(19) United States
(12) Patent Application Publication
(10) Pub. No.: US 2010/0101124 A1
(43) Pub. Date: Apr. 29, 2010

(54) Object Identification System

(76) Inventor: Margaret A. Sorensen, Fountain Hills, AZ (US)

Correspondence Address: NEUSTEL LAW OFFICES, LTD., 2534 SOUTH UNIVERSITY DRIVE, SUITE 4, FARGO, ND, 58103, US

(21) Appl. No.: 12/605,472

(22) Filed: Oct. 26, 2009

Related U.S. Application Data
(60) Provisional application No. 61/197,631, filed on Oct. 28, 2008.

(51) Int. Cl. G09F 3/04

(52) U.S. Cl. 40/306; 40/665

(57) ABSTRACT

An object identification apparatus for efficiently distinguishing an object. The object identification apparatus generally includes a body comprised of a unitary one-piece structure, wherein the body is comprised of an expandable material throughout thereof. The body includes a band portion and an identification portion linearly connected to form a non-ending circular structure to encircle an object, such as a beverage container. The identification portion includes a marking space for writing thereupon with a writing utensil. The identification portion is also generally larger in height and thickness than the band portion.

### CROSS REFERENCE TO RELATED APPLICATIONS

I hereby claim benefit under Title 35, United States Code, Section 119(e) of United States provisional patent application Ser. No. 61/197,631 filed Oct. 28, 2008. The 61/197,631 application is currently pending. The 61/197,631 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an identification tag and more specifically it relates to an object identification system for efficiently distinguishing an object.

2. Description of the Related Art

Any discussion of the related art throughout the specification should in no way be considered as an admission that such related art is widely known or forms part of common general knowledge in the field.

Identification of a specific container among a ground of containers can be difficult when the containers are all of a substantially similar structure, such as a beverage container. Often times, this can lead to individuals using a different container, such as consuming another individual's beverage, thus essentially promoting the spread of germs from individual to individual. Alternately, the individual having difficulty distinguishing their container may choose to simply utilize a new container, to avoid contacting another's germs, thus creating more waste.

A possible solution to distinguish the containers is to use a type of identification method upon the container. However, it is often difficult to place an identification tag on a container that does not permanently attach to the container or permanently mark the container. For various reasons, a consumer may not desire to permanently mark the container or permanently affix an identification element to the container. Because of the inherent problems with the related art, there is a need for a new and improved object identification system for efficiently distinguishing an object.

### BRIEF SUMMARY OF THE INVENTION

An apparatus for efficiently distinguishing an object. The invention generally relates to an identification tag which includes a body comprised of a unitary one-piece structure, wherein the body is comprised of an expandable material throughout thereof. The body includes a band portion and an identification portion linearly connected to form a non-ending circular structure to encircle an object, such as a beverage container. The identification portion includes a marking space for writing thereupon with a writing utensil. The identification portion is also generally larger in height and thickness than the band portion.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the body encircling a beverage container with indicia wrote upon the marking space of the identification portion.

FIG. 2 is an upper perspective view of the body without any indicia upon the identification portion.

FIG. 3 is a rear view of the identification portion.

FIG. 4 is a top view of the body illustrating the shape of the body and the different thicknesses of the band portion and the identification portion.

FIG. 5 is a sectional view taken along lines 5-5 of FIG. 4.

FIG. 6 is a side view of the body encircling a folder and indicia identifying the folder wrote upon the identification portion of the body.

### DETAILED DESCRIPTION OF THE INVENTION

### A. Overview

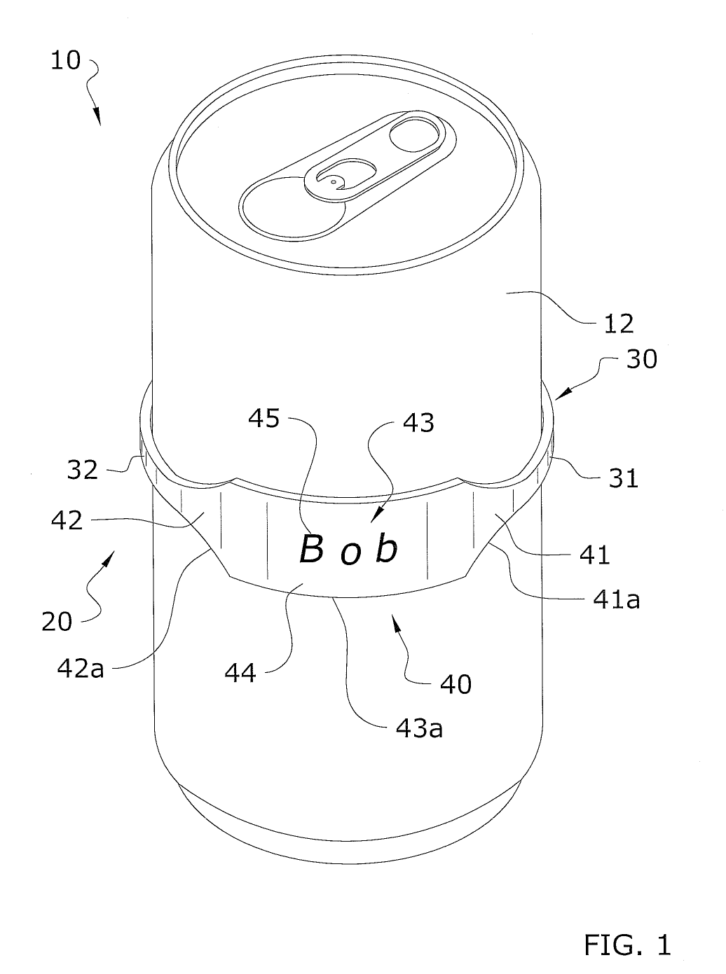

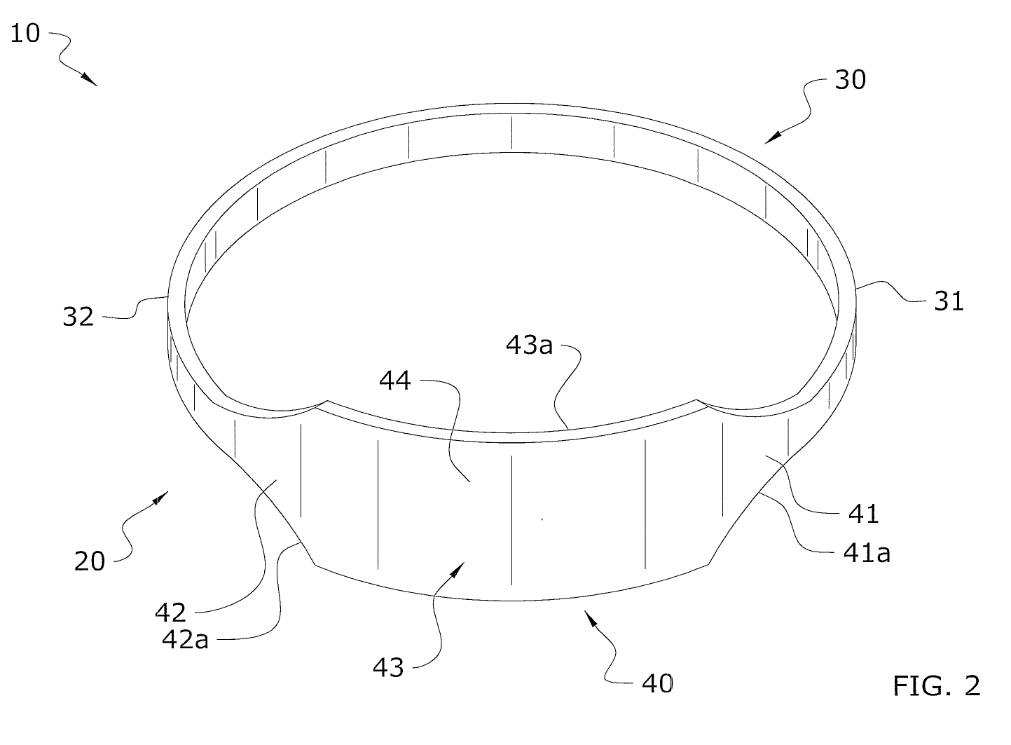

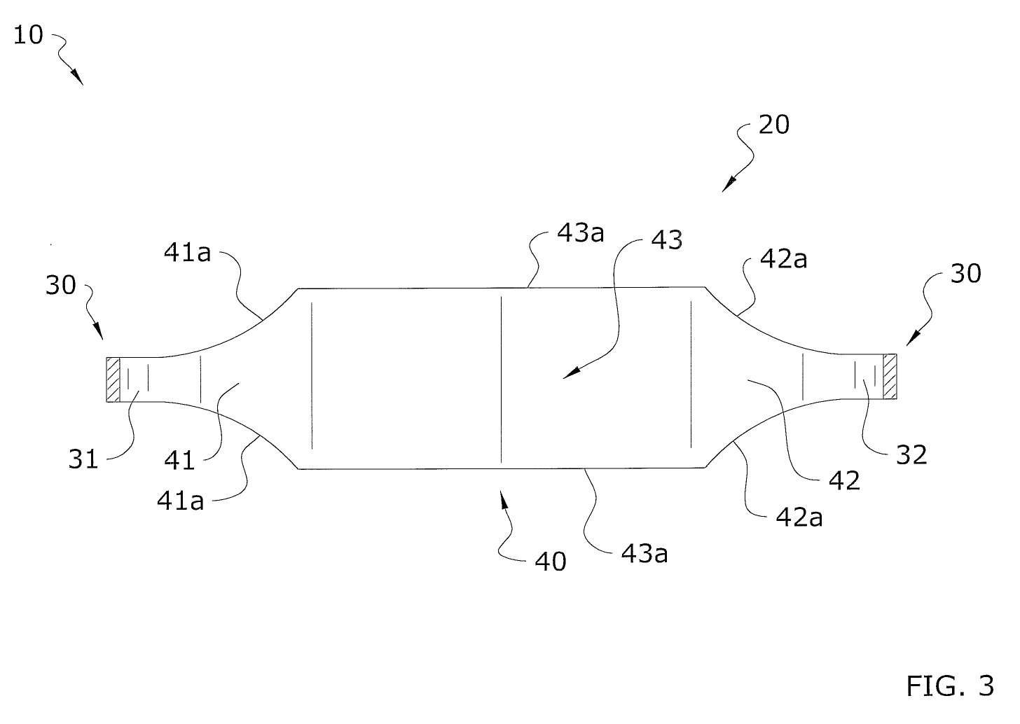

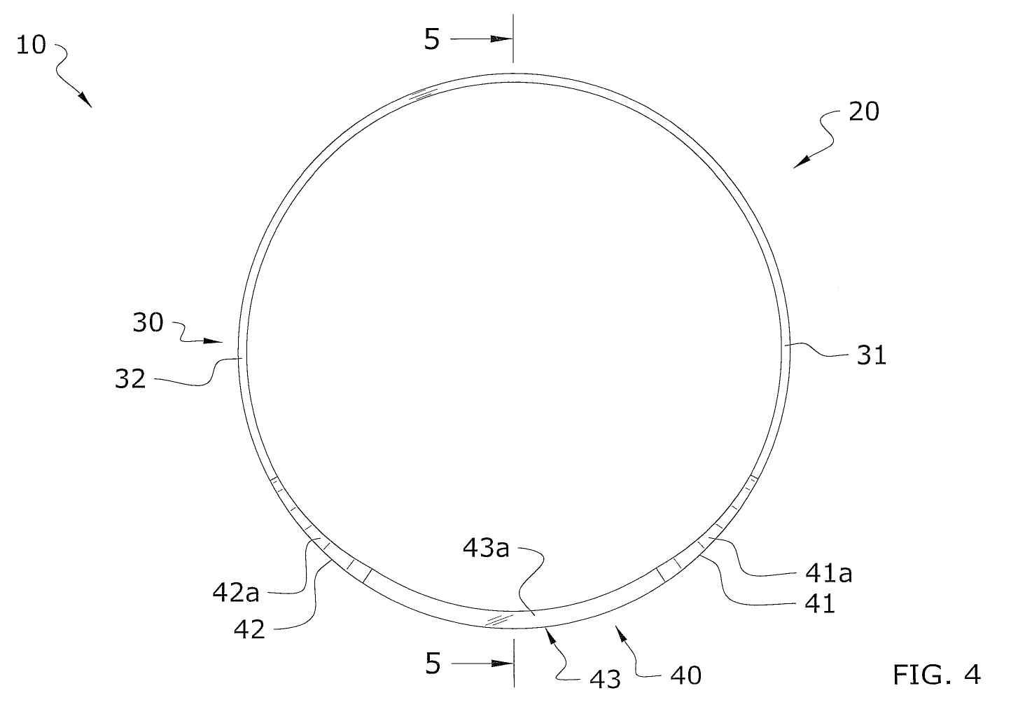

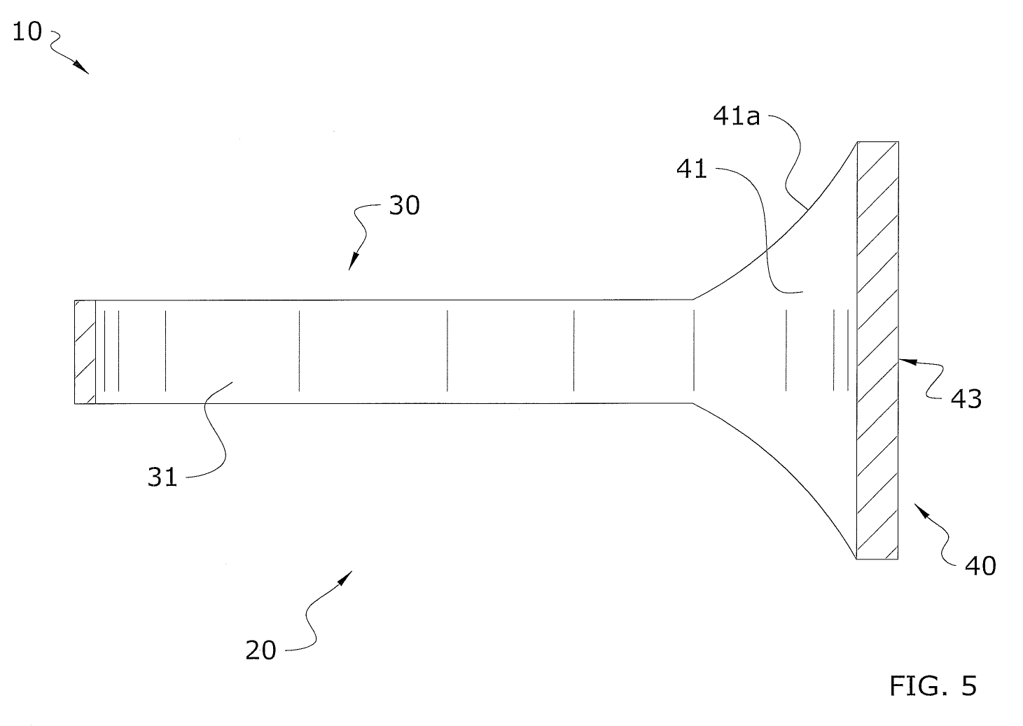

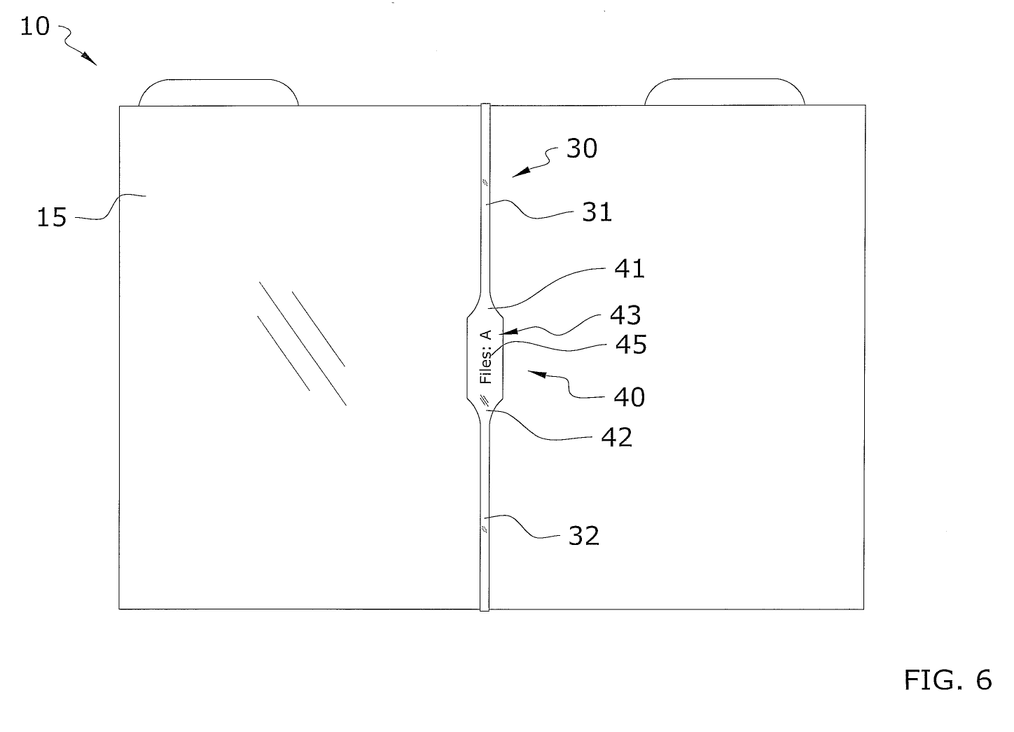

Turning now descriptively to the drawings, in which similar reference characters denote similar elements throughout the several views, FIGS. 1 through 6 illustrate a object identification system 10, which comprises a body 20 comprised of a unitary one-piece structure, wherein the body 20 is comprised of an expandable material throughout thereof. The body 20 includes a band portion 30 and an identification portion 40 linearly connected to form a non-ending circular structure to encircle an object, such as a beverage container 12. The identification portion 40 includes a marking space 44 for writing thereupon with a dry-erase writing utensil. The identification portion 40 is also generally larger in height and thickness than the band portion 30. Other writing utensils may be used as appreciated, such as non-permanent markers, pens, etc.

The object may refer to various types of structures or portions of structures that the body 20 is adapted to encircle. Some examples of objects include beverage containers 12 (e.g. soda bottles, soda cans, coffee cups, etc.), folders 15, files, and food containers. The term “objects” herein may include any type of structure that allows for encircling by the body 20.

### B. Body

The body 20 is comprised of one-piece, unitary structure adapted to encircle an object. The body 20 may be comprised of various perimeters to encircle various size objects. The body 20 is also generally comprised of a similar material throughout, such as but not limited to silicone. The body 20 is thus comprised of a flexible, expandable structure to adapt to and easily removably attach to various size and shape objects. The body 20 is further comprised of a ring, circular structure, such as without a definite end. The body 20 can be used on hot or cold objects and is generally dishwasher, microwave, oven, and freezer safe. The body 20 may also be comprised of various colors for distinguishment.

i. Band Portion.

The band portion 30 of the body 20 is comprised of an elongated strip structure to extend around a substantial portion of the object, wherein the band portion 30 is generally greater in length than the body 20 portion. The band portion 30 is generally thinner than the identification portion to allow for greater flexibility, stretchability, and conformity to the object to allow for easier attachment and removal of the body 20 to the object. The band portion 30 is also generally shorter in height than the identification portion 40 for similar purposes as the thickness difference.

The band portion 30 is continuously uniform in thickness and height throughout the entire length of the band portion 30 from a first end 31 to a second end 32, wherein the first end 31 is opposite the second end 32 along a length of the band portion 30. The identification portion 40 is attached on a first outer portion 41 to the first end 31 and on a second outer portion 42 to the second end 32 to form a linear connection with the band portion 30 and circular structured body 20.

ii. Identification Portion.

The identification portion 40 is used to allow for a user to label the body 20 to correlate with the user or object upon a marking space 44 provided upon the identification portion 40. As stated earlier, the identification portion 40 is comprised of the same material as the band portion 30 and is integrally formed with the band portion 30. The identification portion 40 is also generally comprised of a greater height than the band portion 30 to allow for more marking space 44 and comprised of a greater thickness than the band portion 30 to allow for more rigidity on which to write upon. Also, because the identification portion 40 is large and less stretchable than the band portion 30, the marking space 44 can be marked upon and then stretched around an object without distorting the marking (e.g. writing). Thus, the identification portion 40 can be written on prior to being stretched over an object and also the identification portion 40 can be reused on objects of various sizes without being written on again.

The identification portion 40 generally includes the first outer portion 41 and the second outer portion 42 defining outer ends of the identification portion 40 to attach to the band portion 30. The first outer portion 41 and the second outer portion 42 are tapered in structure thus narrowing in height and thickness to conform to the first end 31 and the second end 32 of the band portion 30. The first outer portion 41 and the second outer portion 42 further generally include inwardly curving or concave edges 41a, 42a to more smoothly adjoin with the band portion 30.

Between the first outer portion 41 and the second outer portion 42 is the central portion 43. The central portion 43 is generally comprised of a rectangular shape and is uniform in thickness and in height both of which are greater than the band portion 30. However other shapes are appreciated with the central portion 43 and identification portion 40 in general. The central portion 43 generally includes straight horizontal outer edges 43a, but it is appreciated that the edges 43a may be concave or convex.

The outer surface of the central portion 43 defines a marking space 44. The marking space 44 is for allowing a user to write a desired form of indicia 45 (e.g. name, type of object, file identification, beverage type, etc.) upon the central portion 43. The user generally writes upon the marking space 44 with a dry-erasable marker, wherein the indicia 45 may be wiped or washed clean after use of the body 20 or when transferring the body 20 to another object thus allowing customization of the body 20.

It is appreciated that the indicia 45 may be wrote upon various other areas of the body 20, such as the first outer portion 41, the second outer portion 42, and the band portion 30 as desired. The dry erase ink of the dry erase marker is generally equally removable from the band portion 30 or the identification portion 40 of the body 20 because the body 20 is comprised of the same material throughout.

### C. Operation of Preferred Embodiment

In use, the object is encircled by the body 20 by stretching the body 20 around the object and allowing the body 20 to retract to a retracted position when positioned at a desired location around the object. The band portion 30 is sufficiently tight around the device while still maintaining the ability to be easily removed. The body 20 may be rotated to an orientation in which the identification portion 40 is desired to be located. A writing utensil, such as a dry erase marker, is then utilized to write or print indicia 45 upon the marking space 44 of the identification portion 40 thus effectively labeling the object in a desired manner to distinguish the object.

After use, the body 20 may be removed from the object and the indicia 45 cleaned from the marking space 44 to allow for reuse of the body 20. It is appreciated that in alternate embodiments, the identification portion 40 may have preexisting indicia 45 thereon. Labels or other adhesive structures may also be affixed to the identification portion 40 as desired.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An apparatus for identification of an object, comprising:
a body comprised of a unitary one-piece structure;
wherein said body is comprised of an expandable material throughout thereof;
wherein said body includes a band portion and an identification portion;
wherein said band portion and said identification portion are linearly connected to form a non-ending circular structure to encircle an object;
wherein said identification portion includes a write on-wipe off marking space formed upon an outer surface of said identification portion for receiving identifying indicia.

2. The apparatus of claim 1, wherein said expandable material is comprised of silicone.

3. The apparatus of claim 1, wherein said band portion is comprised of a first height and wherein said identification portion is comprised of a second height, wherein said second height is greater than said first height.

4. The apparatus of claim 1, wherein said band portion is comprised of a first thickness and wherein said identification portion is comprised of a second thickness, wherein said second thickness is greater than said first thickness.

5. The apparatus of claim 1, wherein said identification portion includes:
a first outer portion extending directly from a first end of said band portion;
a second outer portion extending directly from a second end of said band portion, wherein said first outer portion is opposite said second outer portion along a longitudinal length of said identification portion; and
a central portion extending directly between said first outer portion and said second outer portion.

6. The apparatus of claim 5, wherein said first outer portion and said second outer portion are comprised of a tapered structure.

7. The apparatus of claim 6, wherein said tapered structure tapers in height and thickness.

8. The apparatus of claim 7, wherein said tapered structure of said first outer portion and said second outer portion includes a pair of concave outer edges.

9. The apparatus of claim 5, wherein said identification portion is comprised of silicone.

10. The apparatus of claim 5, wherein said central portion includes said write on-wipe off marking space formed upon an outer surface of said central portion.

11. An apparatus for identification of an object, comprising:
a body comprised of a unitary one-piece structure;
wherein said body is comprised of an expandable material throughout thereof;
wherein said body includes a band portion and an identification portion;
wherein said band portion and said identification portion are linearly connected to form a non-ending circular structure to encircle an object;
wherein said band portion is comprised of a first height and wherein said identification portion is comprised of a second height, wherein said second height is greater than said first height;
wherein said band portion is comprised of a first thickness providing a first flexibility to said band portion and wherein said identification portion is comprised of a second thickness providing a second flexibility to said identification portion;
wherein said second thickness is greater than said first thickness and wherein said first flexibility is greater than said second flexibility.

12. The apparatus of claim 11, wherein said expandable material is comprised of silicone.

13. The apparatus of claim 11, wherein said identification portion includes a write on-wipe off marking space formed upon an outer surface of said identification portion for receiving identifying indicia.

14. The apparatus of claim 11, wherein said identification portion includes:
a first outer portion extending directly from a first end of said band portion;
a second outer portion extending directly from a second end of said band portion, wherein said first outer portion is opposite said second outer portion along a longitudinal length of said identification portion; and
a central portion extending directly between said first outer portion and said second outer portion.

15. The apparatus of claim 14, wherein said first outer portion and said second outer portion are comprised of a tapered structure.

16. The apparatus of claim 15, wherein said tapered structure tapers in height and thickness.

17. The apparatus of claim 16, wherein said tapered structure of said first outer portion and said second outer portion includes a pair of concave outer edges.

18. The apparatus of claim 14, wherein said central portion includes a write on-wipe off marking space formed upon an outer surface for receiving identifying indicia.

19. The apparatus of claim 14, wherein said identification portion is comprised of silicone.

20. A beverage container identification system, comprising:
a beverage container;
a body comprised of a unitary one-piece structure;
wherein said body is comprised of an expandable silicone material throughout thereof;
wherein said body includes a band portion and an identification portion;
wherein said band portion and said identification portion are linearly connected to form a non-ending circular structure to encircle said beverage container;
wherein said identification portion includes a dry-erase write on-wipe off marking space formed upon an outer surface of said identification portion;
wherein said band portion is comprised of a first height and wherein said identification portion is comprised of a second height, wherein said second height is greater than said first height;
wherein said band portion is comprised of a first thickness and wherein said identification portion is comprised of a second thickness, wherein said second thickness is greater than said first thickness;
wherein said identification portion includes a first outer portion extending directly from a first end of said band portion;
wherein said identification portion includes a second outer portion extending directly from a second end of said band portion;
wherein said first outer portion is opposite said second outer portion along a longitudinal length of said identification portion;
wherein said identification portion includes a central portion extending directly between said first outer portion and said second outer portion;
wherein said first outer portion and said second outer portion are comprised of a tapered structure;
wherein said tapered structure tapers in height and thickness;
wherein said tapered structure of said first outer portion and said second outer portion includes a pair of concave outer edges; and
a dry-erase marker for writing upon said marking space of said identification portion.
